(19) United States
(12) Patent Application Publication
(10) Pub. No.: US 2004/0098606 A1
(43) Pub. Date: May 20, 2004

(54) System, method and program product for operating a grid of service providers based on a service policy

(75) Inventors: Yih-Shin Tan, Raleigh, NC (US); Vivekanand Vellanki, Raleigh, NC (US); Jie Xing, Cary, NC (US)

Correspondence Address: Jeanine S. Ray-Yarletts, IBM Corporation T81/503, PO Box 12195, Reasearch Triangle Park, NC, 27709, US

(73) Assignee: International Business Machines Corporation, Armonk, NY

(21) Appl. No.: 10/298,962

(22) Filed: Nov. 18, 2002

(51) Int. Cl. G06F 11/30

(52) U.S. Cl. 713/200

(57) ABSTRACT

Under the present invention, a user-issued request for services is received and validated based on the service policy. Once validated, an initial set of service providers from a grid are identified. Once identified, the set can be dynamically varied based on monitored performances of the service providers, and/or based on the discovery of other service providers from other grids. Once the set is finalized, one or more particular service providers are selected to process the request. This system allows the grid to automatically respond to events monitored to optimize and provide reliable operations.

### BACKGROUND OF THE INVENTION

1. Field of the Invention

The present invention generally relates to a system, method and program product for operating a grid of services such as service providers based on a service policy. Specifically, based on rules within the service policy, the present invention allows: (1) one or more services/providers from the grid to be selected to process a request for services; and (2) the grid to automatically adjust its operations.

2. Background Art

As the use of the Internet grows, computer users are increasingly conducting everyday transactions on-line. For example, today a user can order a product or a service, obtain information, or conduct a business transaction using world wide web sites. In general, when a user is seeking services on-line, he/she must first identify an appropriate service provider. Given that multiple service providers could offer the same services, the user might be presented with a litany of options. Moreover, due to the nature of the world wide web, the user's search might not reveal the best (e.g., most efficient, cost effective, etc.) service provider.

In an attempt to address some of these concerns, registries such as the Universal Description, Discovery and Integration (UDDI) Directory have been developed. The UDDI is an XML registry for businesses and invocable Web Services listed on a network such as the Internet. It is often thought of as a “telephone” directory for businesses and service-providers to be listed by name, product, location or the web services they offer. Unfortunately, provider directories such as the UDDI do little for the user beyond helping to identify a set of providers. That is, the provider directories fail to provide any “screening” or “selection” of a particular provider based on certain criteria or policies. Moreover, the provider directories do not act as an interface between the user and the providers listed therein. That is, once providers have been identified, it is up to the user to select a particular provider and then communicate therewith to conduct the desired transaction. Thus, no existing system provides a way for a particular provider to be automatically selected based on established criteria and/or policies.

In view of the foregoing, there exists a need for a system in which service providers can be selected based on an established service policy and/or criteria. Specifically, there exists a need for the service providers to be grouped into a grid or similar structure. A need also exists for users and the service providers to be assigned a service level based on an indicated quality of service (QoS). Still yet, there exists a need for a set of the service providers in the grid, which are capable of processing a request sent from the user, to be identified based on the service policy and the assigned service levels. An additional need exists for the set to be varied based on measured performances of the service providers and/or the discovery of other service providers in other grids. A further need exists for a particular service provider to be selected from the set based on the service policy and any user established criteria. Another need exists for such a system to respond to operational events automatically such that it is self-configured, self-optimized, and self-healing to accommodate the services (service providers) that join and leave the grid dynamically.

### SUMMARY OF THE INVENTION

In general, the present invention provides a system, method and program product for operating a grid of service providers based on a service policy. Specifically, under the present invention, service providers are contracted and then grouped into a grid. Under the contracts, each service provider is assigned a service level that is based on a proposed quality of service (QoS) and other any factors deemed important such as designated features and feebase. Then, a user desiring to obtain services will transmit a request. Based on: (1) the user's contacted service level; (2) the providers' contracted service levels and (3) mapping rules set forth in the service policy, a set of providers that are most capable of processing the request will be identified. Once identified, the set can be varied based on monitoring and discovery rules to accommodate for monitored performances of the providers and/or discovery of other providers in other grids. One or more particular providers from the set will then be selected to process the request based on selection rules in the policy and any criteria set forth by the user.

According to a first aspect of the present invention, a system for operating a grid of service providers based on a service policy is provided. The system comprises: (1) a security system for validating an identity of a user transmitting a request based on the service policy, and for accessing a profile corresponding to the user; (2) a mapping system for identifying a set of the service providers in the grid capable of processing the request, wherein the set of service providers is identified based on the service policy, a user service level identified in the profile, and provider service levels corresponding to the service providers; and (3) a selection system for selecting a particular service provider from the set based on the service policy.

According to a second aspect of the present invention, a system for operating a grid of service providers based on a service policy is provided. The system comprises: (1) a security system for validating an identity of a user transmitting a request based on a set of security rules in the service policy, and for accessing a profile corresponding to the user; (2) a mapping system for identifying a set of the service providers in the grid capable of processing the request, wherein the set of service providers is identified based on a set of mapping rules in the service policy, a user service level identified in the profile, and provider service levels corresponding to the service providers; (3) a discovery system for identifying additional service providers for the set from another grid based on a set of discovery rules in the service policy; and (4) a selection system for selecting a particular service provider from the set based on a set of selection rules in the service policy.

According to a third aspect of the present invention, a method for operating a grid of service providers based on a service policy is provided. The method comprises: (1) receiving a request from a user, and validating an identity of the user based on a set of security rules in the service policy; (2) accessing a profile corresponding to the user; (3) identifying a set of the service providers in the grid capable of processing the request, wherein the set is identified based on a set of mapping rules in the service policy, a user service level identified in the profile, and provider service levels corresponding to the service providers; and (4) selecting a particular service provider from the set based on a set of selection rules in the service policy.

According to a fourth aspect of the present invention, a program product stored on a recordable medium for operating a grid of service providers based on a service policy is provided. When executed, the program product comprises: (1) program code for validating an identity of a user transmitting a request based on a set of security rules in the service policy, and for accessing a profile corresponding to the user; (2) program code for identifying a set of the service providers in the grid capable of processing the request, wherein the set of service providers is identified based on a set of mapping rules in the service policy, a user service level identified in the profile, and provider service levels corresponding to the service providers; and (3) program code for selecting a particular service provider from the set based on a set of selection rules in the service policy.

Therefore, the present invention provides a system, method and program product for operating a grid of service providers based on a service policy.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a system for operating a grid of service providers based on a service policy according to the present invention.

FIG. 2 depicts more detailed diagram of the system of FIG. 1.

FIG. 3 depicts a method flow diagram according to the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, the present invention provides a system, method and program product for operating a grid of service providers based on a service policy. The service policy includes, among other things, service level definitions, mapping rules, security rules, monitoring rules, discovery rules, selection rules and recovery rules. The service policy is used to manage transactions between users and service providers. In addition, the service policy allows the grid to automatically adjust its operations. That is, the service policy allows the grid to respond to operational events automatically such that it is self-configured, self-optimized and self-healing to accommodate the services/service providers that join and leave the grid dynamically.

Under the present invention, service providers are contracted and grouped into a grid. Under the contracts, each service provider is assigned a service level (as defined in the policy) that is based on a proposed quality of service (QoS) and any other factors deemed important such as designated features and feebase. Then, a contracted/registered user desiring to obtain services will transmit a request. Based on: (1) the user's contacted service level; (2) the providers' contracted service levels and (3) mapping rules set forth in the service policy, a set of providers that are capable of processing the request will be identified from the grid. Once identified, the set can be dynamically varied based on monitoring and discovery rules to accommodate for monitored performances of the providers and/or discovery of other providers in another grid. Then, one or more particular providers from the set will be selected to process the request based on selection rules in the policy and any criteria set forth by the user.

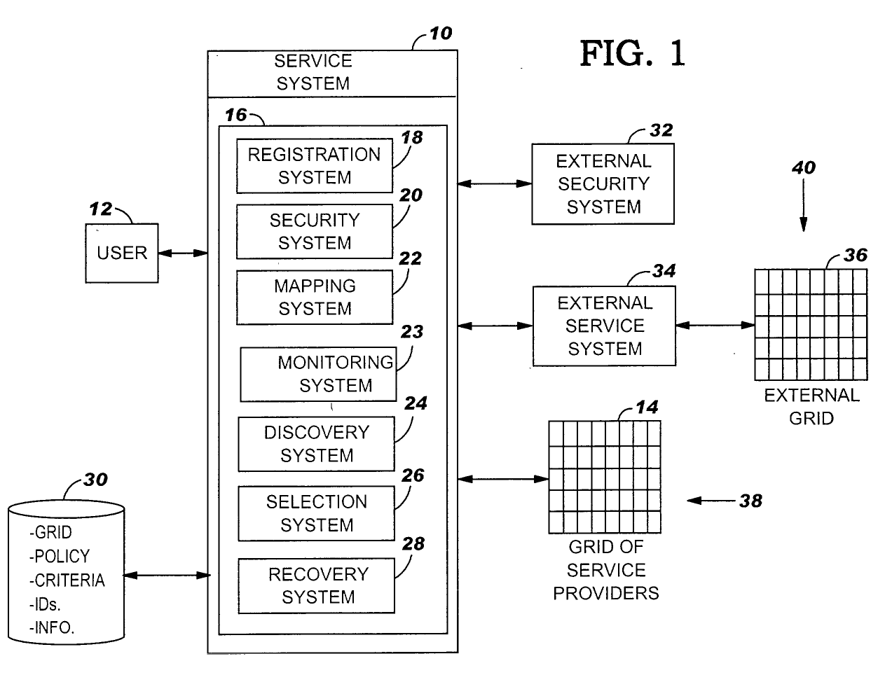

Referring now to FIG. 1, service system 10 in communication with user 12 and grid 14 of service providers 38 is shown. User 12 is intended to represent any computer user who orders goods or services from service providers 38 over a network (e.g., the Internet). It should be understood that although not shown, user 12 typically communicates with service system 10 via a computerized system such as a personal computer, workstation, personal digital assistant, etc. Grid 14 is intended to represent a group or collection of service providers 38. Under the present invention, service providers 38 are grouped into a grid to provide automatic request processing, monitoring, event notifications, etc. To this extent, all service providers 38 in grid could communicate in a common format/protocol. This prevents user 12 or service system 10 from having to accommodate a litany of disparate formats/protocols. In the event that service providers 38 do not adopt a common format/protocol, service system 10 could be provided with the resources to make any necessary translations. It should also be understood that although referred to herein as “service” providers, providers 38 within grid 14 are intended to represent any individuals, group of individuals, company, system, component, or program that provides goods or services over a network. To this extent, “service providers” mean, in the context of a Service Oriented Architecture, (e.g., Web and Grid Services), any service instances that provide well defined service interface descriptions (e.g., through WSDL). In this case, the service instances could be provided over a computer complex such as an enterprise or a broad network such as the Internet.

In order for user 12 and service providers 38 to utilize service system 10 to conduct business, they must first contract/register via registration system 18 of request system 16. Registration generally includes, among other things, the establishment Service Level Agreements (SLAs), and any necessary security precautions. The SLAs set forth a particular “service level” for each contracting user 12 and service provider 38. The various service levels available to user 12 and service providers 38 are typically defined in the service policy (e.g., as stored in database 30). The service levels are generally based on a Quality of Service (QoS) as well as any defined features and/or feebase. Specifically, when user 12 is registering, he/she will likely provide a user name and password, and select a desired user service level (e.g., gold, silver or bronze). Each user service level is based on quality of service (QoS) level desired by user 12. For example, the user services levels of gold, silver and bronze, can correspond to the QoS levels of best, better and good, respectively. In determining the users desired QoS levels, several factors can be considered. Such factors can include, for example, desired availability (e.g., 95% of the time) and responsiveness (e.g., immediately) of service providers 38. The particular service level selected by or assigned to user 12 could be dependent on the fee paid. For example, gold level users might be required to pay a highly monthly fee than silver level users. Once user 12 has been assigned/selected a service level, it can be stored in database 30 within user 12's profile. To this extent, user 12's profile could also set forth at least one criterion he/she may have for transacting with service providers 38 (e.g., maximum price user 12 is willing to pay, needed turn around time, etc.).

In a similar fashion, upon registration each service provider 38 will select or be assigned a provider service level (e.g., premier, preferred and trial). These levels also correspond to QoS levels (e.g., category 5, category 4 and category 3, respectively) as well as any defined features and/or feebase. In this case, however, the service levels are based on the QoS levels that service providers 38 are willing to provide (as opposed to user 12 who indicates the QoS level he/she desires to obtain). Service providers 38's QoS levels can be determined based on numerous factors. Such factors can include, for example, availability, responsiveness, maximum quantity of requests the provider can handle, turnaround, time-outs, quantity of requests that must be retried, whether event notifications are carried out synchronously or asynchronously, whether the service provider's system is cloneable, whether the workload is managed, whether the provider's connection is secure, etc. Once a particular service provider has registered, the service provider will become a member of grid 14.

After user 12 and service providers 38 have registered, user 12 can utilize service system 10 to transact with one or more appropriate service providers 38. For example, if user 12 wishes to obtain financial information, user 12 will generate and transmit a request, which will be received by security system 20. The request will typically include the desired service/product, user 12's identification and password, as well as any criteria (not previously specified) user 10 has for fulfilling the request. Moreover, the request can be generated using any known means such as a web browser loaded on a computerized system (not shown) operated by user 12. Upon receipt of the request, security system 20 will first automatically validate the identify of user 12 to ensure that he/she is a registered/authorized user. To this extent, validation can be based on a set (e.g., 1 or more) of security rules within the service policy. For example, the security rules could dictate that the user identification and password in the request be compared against a list of registered users in database 30. Moreover, the security rules could set forth the user identifications of all users deemed to be “trusted.” If a “trusted” user identification is received, validation may be unnecessary. Still yet, the security rules could dictate that users sending requests for “general” services need not be validated. Regardless of the particular scenario, the set of security rules help prevent unauthorized users from accessing service system 10.

Once user 12's identification has been validated, security system 20 will access user 12's profile (e.g., within database 30). As indicated above, user 12's profile will indicate the user service level and possibly any additional information (e.g., criteria) user 12 established for purchasing services when initially registering. In another embodiment, security services are provided by external security system 32 (in lieu of security system 20). In this case, valid identifications, passwords and/or user profiles could be stored on external security system 32. Validation of the identification of user 12 by external security system 32 would occur in the same manner. Specifically, a set of security rules would be followed to determine if the request was transmitted from a registered or authorized user. In any event, it should be appreciated that security system 20 and external security system 32 should be able to work in conjunction with any user front end system such as International Business Machines Corp's Service Provisioning Manager, Various Business Integrator Gateway, WebSphere Application server, etc.

Once user 12's identity has been validated, mapping system 22 will automatically identify an initial set of service providers 38 from grid 14 that are capable of processing the request. In a typical embodiment, the set is initially determined based on the service being requested. For example, if user 12 is requesting financial information, only those service providers that can provide financial information should be considered (e.g., service providers A-F). Then, a set of mapping rules in the service policy will narrow the set by correlating user service levels with provider service levels. For example, the set of mapping rules could dictate that: (1) gold level users can only be serviced by premier and preferred level services providers; (2) silver level users by preferred and trial level service providers; and (3) bronze level users by trial level service providers. Thus, assuming for example that user 12 is a gold level user, mapping system 22 would identify premier service level providers A-B and preferred level service providers C-D as the initial set. Trial level service providers E-F would not be considered for the time being.

Once a set of service providers 38 has been initially identified, it can be dynamically varied by monitoring system 23 based on monitored performances of the service providers 38 and a set of monitoring rules in the service policy. Specifically, event handlers within monitoring system 23 will monitor the performance of each service provider 38. Based on whether performance meets, exceeds or falls below expectations, the set can be altered. For example, if service provider A has an availability that falls below the premier or preferred standards (e.g., 50%), the monitoring rules could dictate that provider A must be dropped from the set. Conversely, if trial service level provider E (not initially identified) has a performance that brings him/her up to preferred or premier levels, provider E could be added to the set. Typically, the monitoring rules will allow for a service provider dropped from the set to be reevaluated for possible promotion back to its contracted service level.

Discovery system 24 allows the set to be further dynamically varied by adding service providers 40 from another, external grid 36. Discovery of other service providers 40 allows user 12 to be provided with more complete service. For example, if user 12 is requesting the services of A-F, and the identified set of service providers 38 can only provide the services of A-C, discovery system 24 will search for other service providers that can provide the missing services of D-F. Typically, discovery is accomplished according to a set of discovery rules in the service policy that can be carried out beforehand or on-demand. For example, the set of discovery rules could dictate that if requested services cannot be delivered by service providers 38 within grid 14, a query is generated and sent to external service system. Upon receiving the query, external service system 34 would search its grid 36 to identify a set of service providers 40 that can provide the needed services. To this extent, a set of translation rules in the service policy, or a translation table in database 30 could provide the resources for discovery system 24 to translate the communication format/protocol of service providers 40 to the format/protocol used by service system 10. Specifically, service providers 40 in grid 36 could communicate using different verbiage, message formats or communication protocols than used by service providers 38 in grid 14. In such an event, discovery system 24 will use resources in the service policy or database 30 to make any necessary translations.

Once the set of service providers has been made “final,” selection system 26 will automatically select one or more particular service providers from the set to deliver the requested services. In general, the particular service provider(s) is selected based on a set of selection rules in the service policy. For example, the selection rules could dictate that a particular service provider is selected based on a time/day of the request, existing business relationships, user criteria specific in the request or user profile, or any miscellaneous considerations.

With respect to selecting a particular service provider based on a business relationship, it could be the case that certain service providers were promised a minimum number of transactions in a period of time under their SLAs. For example, premier level service providers could have been promised 1000 transactions a month. In this case, a counter will keep track of the quantity of transactions the service providers are receiving. The request can be routed to the service providers according to the current count level. Once a service provider has reached his/her promised count, the contracted count level will not be a factor in selection.

Also shown in FIG. 1 is recovery system 28, which utilizes a set of recovery rules in the service policy to address any problems or errors that may arise. Examples of errors that could occur include communication failures, security breaches, etc. Recover system 28 and the recovery rules thus help maintain a continuous and automated operation of service system 10.

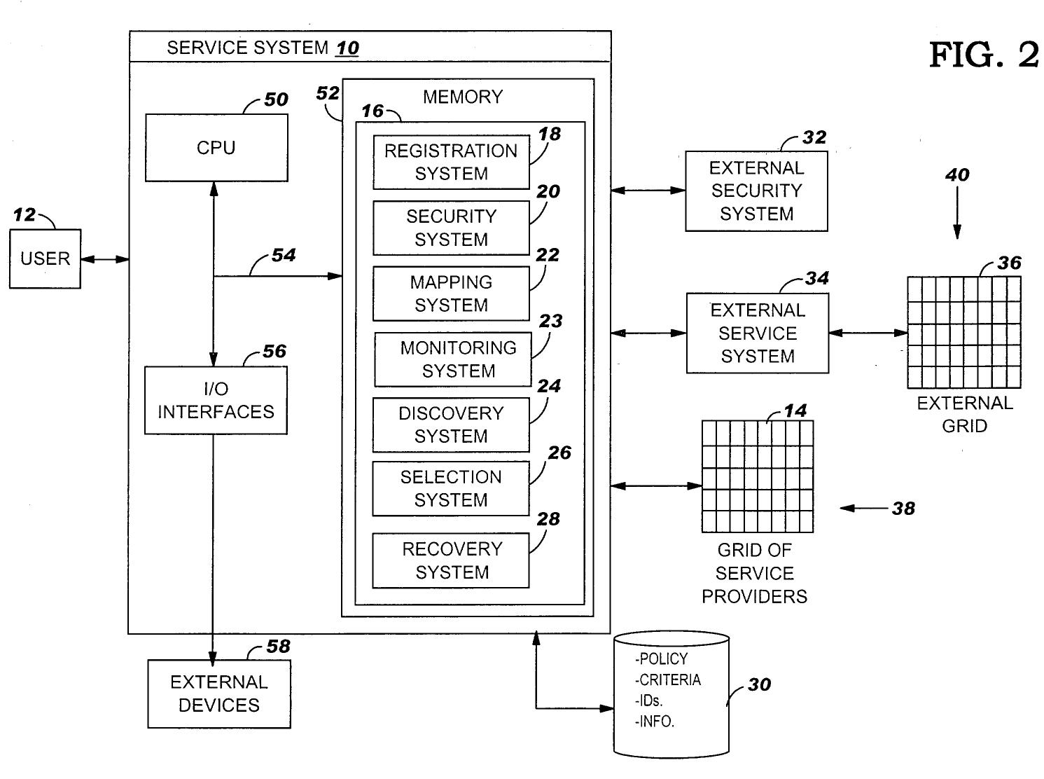

Referring now to FIG. 2, a more detailed diagram of service system 10 is shown. As depicted, service system 10 generally includes central processing unit (CPU) 50, memory 52, bus 54, input/output (I/O) interfaces 56 and external devices/resources 58. CPU 50 may comprise a single processing unit, or be distributed across one or more processing units in one or more locations, e.g., on a client and server. Memory 52 may comprise any known type of data storage and/or transmission media, including magnetic media, optical media, random access memory (RAM), read-only memory (ROM), a data cache, a data object, etc. Moreover, similar to CPU 50, memory 52 may reside at a single physical location, comprising one or more types of data storage, or be distributed across a plurality of physical systems in various forms.

I/O interfaces 56 may comprise any system for exchanging information to/from an external source. External devices/resources 58 may comprise any known type of external device, including speakers, a CRT, LED screen, hand-held device, keyboard, mouse, voice recognition system, speech output system, printer, monitor, facsimile, pager, etc. Bus 54 provides a communication link between each of the components in service system 10 and likewise may comprise any known type of transmission link, including electrical, optical, wireless, etc. In addition, although not shown, additional components, such as cache memory, communication systems, system software, etc., may be incorporated into service system 10.

Database 30 is optional and could provide storage for information under the present invention. Such information could include, for example, a service policy, user criteria, user profiles, user identifications and passwords, general information, etc. As such, database 30 may include one or more storage devices, such as a magnetic disk drive or an optical disk drive. In another embodiment, database 30 includes data distributed across, for example, a local area network (LAN), wide area network (WAN) or a storage area network (SAN) (not shown). Database 30 may also be configured in such a way that one of ordinary skill in the art may interpret it to include one or more storage devices.

It should be understood that communication among service system 10, user 12, grid 14, external security system 32 and external service system 34 can occur via a direct hardwired connection (e.g., serial port), or via an addressable connection in a client-server (or server-server) environment which may utilize any combination of wireline and/or wireless transmission methods. In the case of the latter, the server and client may be connected via the Internet, a wide area network (WAN), a local area network (LAN), a virtual private network (VPN) or other private network. The server and client may utilize conventional network connectivity, such as Token Ring, Ethernet, WiFi or other conventional communications standards. Where the client communicates with the server via the Internet, connectivity could be provided by conventional TCP/IP sockets-based protocol. In this instance, the client would utilize an Internet service provider to establish connectivity to the server.

Stored in memory 52 of service system 10 is request system 16, which processes requests from user 12. As shown, request system 16 includes registration system 18, security system 20, mapping system 22, monitoring system 23, discovery system 24, selection system 26 and recovery system 28 (the functions of which were described in detail above). In general, the systems within request system 16 comprise program code and/or interfaces for carrying out their particular functions.

Specifically, registration system 18 could include a user interface for user 12 and service providers 38 to provide biographical information, select a QoS-based service level, provide any user names and passwords, designate any criteria, etc. Shown below is exemplary program code that illustrates how service levels correspond to QoS levels for both user 12 and service providers 38:

```
<service_levels-section type=“USER”>
  <servicelevel name=“GOLD” feebase=“feebase1” qos=“BEST”>
    <operation name=“getQuoteMultiple” />
    <operation name=“getQuoteDescriptive” qos=“BETTER” />
    <operation name=“getAddress” />
    <operation name=“purchaseOrder” />
  </servicelevel>
  <servicelevel name=“SILVER” feebase=“feebase2”
  qos=“BETTER”>
    <operation name=“getQuoteDescriptive” />
    <operation name=“getAddress” />
    <operation name=“purchaseOrder” />
  </servicelevel>
  <servicelevel name=“BRONZE” feebase=“feebase3”
  qos=“GOOD”>
    <operation name=“getQuoteSingle” />
    <operation name=“purchaseOrder” />
  </servicelevel>
<service_levels-section type=“SUPPLIER”>
  <servicelevel name=“PREMIER” feebase=“feebaseA”
  qos=“Catagory5”>
    <operation name=“getQuoteMultiple” />
    <operation name=“getQuoteDescriptive” qos=“BETTER” />
    <operation name=“getAddress” />
    <operation name=“purchaseOrder” />
  </servicelevel>
  <servicelevel name=“PREFERRED” feebase=“feebaseB”
  qos=“Catagory4”>
    <operation name=“getQuoteDescriptive” />
    <operation name=“getAddress” />
    <operation name=“purchaseOrder” />
  </servicelevel>
  <servicelevel name=“TRIAL” feebase=“feebaseC”
  qos=“Catagory3”>
    <operation name=“getQuoteSingle” />
    <operation name=“purchaseOrder” />
  </servicelevel>
```

Once any registration information has been determined, it can be stored in database 30 (e.g., for user 12 in a user profile). When user 12 later submits a request, security system 20 or external security system 32 will validate user 12's identification. As indicated above, validation is performed according to a set of security rules in the service policy. Listed below is exemplary program code that can be used for validating user 12's identification:

```
<security-procedure-section default=“Login”>
      <security-procedure name=“Login”
      intrustion_warning=“*|YES|NO” />
  <security-procedure name=“Trusted” audit=“*|YES|NO” />
  <security-procedure name=“General” />
  <security-procedure name=“AcceptValidIdentity”
  audit=”*|YES|NO”>
    <Identity Name=“Freestone” ref=“url handle to the source
    authenticator” />
    <Identity Name=“WebSphere” ref=“url handle to the source
    authenticator” />
    <Identity Name=“Allegro” ref=“url handle to the source
    authenticator” />
    <Identity Name=“BIG” ref=“url handle to the source
    authenticator” />
  </security-procedure>
</security-procedure-section>
```

Once user 12's identification has been validated, mapping system 22 will identify an initial set of service providers 38 from grid 14. As described, this not only includes identifying appropriate service providers 38 based on the services requested, but also involves applying a set of mapping rules to correlate user service levels with service provider levels. Listed below is program code that can be used for such a correlation:

```
<servicemap name=“default”>
  <pool name=“GOLDSuppliers” user_servicelevel=“GOLD”>
    <condition-set type=“or”>
      <condition name=“supplier_servicelevel”
      value=“PREMIER” />
      <condition name=“Supplier_servicelevel”
      value=“PREFERRED” />
    </condition-set>
  </pool>
  <pool name=“SILVERSuppliers” user_servicelevel=“SILVER”>
    <condition-set type=“or”>
      <condition name=“supplier_servicelevel”
      value=“PREFERRED” />
      <condition name=“Supplier_servicelevel”
      value=“TRIAL” />
    </condition-set>
  </pool>
  <pool name=“BRONZESuppliers” user_servicelevel=“BRONZE”>
    <condition-set type=“or”>
      <condition name=“supplier_servicelevel” value=“TRIAL” />
    </condition-set>
  </pool>
```

As indicated above, monitoring system 23 can dynamically vary the set of service providers 38 by adding or removing service providers based on their monitored performances (e.g, as monitored with event handlers). This allows under-performing service providers 38 to be removed from the set, while allowing highly-performing service providers 38 to be added to the set. List below is exemplary program code that can provide such dynamic variation:

```
<servicemap name=“Observed_Service_Levels”>
  <pool name=“GOLDSuppliers” user_servicelevel=“GOLD”>
      <condition-set type=“and”>
          <condition name=“pool” value=“GOLDSuppliers” />
          <condition name=“Availability” value=“95” />
          <condition name=“Responsiveness” value=“5” />
        </condition-set>
    </pool>
    <pool name=“SILVERSuppliers” user_servicelevel=“SILVER”>
        <condition-set type=“and”>
          <condition name=“pool” value=“SILVERSuppliers” />
      <condition name=“Availability” value=“90” />
          <condition name=“Responsiveness” value=“5” />
          </condition-set>
    </pool>
    <pool name=“BRONZESuppliers” user_servicelevel=“BRONZE”>
      <condition-set type=“and”>
          <condition name=“pool” value=“BRONZESuppliers” />
          <condition name=“Availability” value=“80” />
          <condition name=“Responsiveness” value=“10” />
        </condition-set>
    </pool>
  </servicemap>
servicemap name=“Reenlist”>
    <pool name=“GOLDSuppliers” user_servicelevel=“GOLD”>
      <condition-set type=“or”>
        <condition name=“pool” value=“GOLDSuppliers” />
        <condition-set type=“and”>
        <condition name=“Availability” value=“95” />
          <condition name=“Responsiveness” value=“5” />
      </condition-set>
        </condition-set>
  </pool>
  <pool name=“SILVERSuppliers” user_servicelevel=“SILVER”>
    <condition-set type=“or”>
        <condition name=“pool” value=“SILVERSuppliers” />
        <condition-set type=“and”>
          <condition-set type=“or”>
          <condition name=“supplier_servicelevel”
          value=“PREFERRED” />
          <condition name=“Supplier_servicelevel”
          value=“TRIAL” />
        </condition-set>
      <condition name=“Availability” value=“90” />
        <condition name=“Responsiveness” value=“5” />
    </condition-set>
      </condition-set>
  </pool>
  <pool name=“BRONZESuppliers” user_servicelevel=“BRONZE”>
    <condition-set type=“or”>
        <condition name=“pool” value=“BRONZESuppliers” />
        <condition-set type=“and”>
      <condition name=“Supplier_servicelevel” value=“TRIAL” />
      <condition name=“Availability” value=“80” />
          <condition name=“Responsiveness” value=“10” />
    </condition-set>
      </condition-set>
  </pool>
```

The set of service providers 38 can then be further dynamically varied to include service providers 40 from another grid 36. As explained above, discovery system 24 will utilize a set of discovery rules in the service policy to identify such service providers 40 and to perform any necessary communication translation. Shown below is exemplary program code that can provide such discovery:

```
  <service-discovery-section>
    <discover from=“url handle to the source service desk”
    type=“transient”>
      <querystring value=“xPath query string for utility
      service instances” />
    </discover>
    <discover name=“url handle to the source service desk”
    type=“persist”>
      <querystring value=“xPath query string for system
      service instances” />
      <lifecycle value=“good_till_reset” />
      <servicelevel value=“SYSTEM” />
        <condition-set type=“and”>
          <condition name=“event_Feature Error” value=“” />
        </condition-set>
    </discover>
    <discover name=“url handle to the source service desk”
    type=“persist”>
      <queryname value=“StockQuotePortType” />
      <lifecycle value=“specify a termination date” />
      <servicelevel value=“trial” />
  </discover>
</service-discovery-section>
```

Once the set of service providers has been finally determined, selection system 26 will utilize selection rules to select one or more particular service providers to process the request. To this extent, selection can be based on any number of factors such as day/time of request, business relationships, user criteria, etc. Accordingly, the following exemplary program code can be used within selection system 26 to enable provider selection:

```
<selection-rule trigger=“OfficeHours”>
      <condition-set type=“and”>
        <condition name=“servicelevel” value=“GOLD” />
      </condition-set>
      <action directive=“Availability” />
  </selection-rule>
  <selection-rule trigger=“EveningHours”>
      <condition-set type=“and”>
        <condition name=“servicelevel” value=“GOLD” />
      </condition-set>
      <action directive=“TurnAround” />
  </selection-rule>
  <selection-rule>
      <condition-set type=“and”>
        <condition name=“Priority” value=“1” />
      </condition-set>
      <action affinity=“Supplier_PREMIER” />
  </selection-rule>
  <selection-rule>
      <condition-set type=“and”>
        <condition name=“operation” value=“getAddress” />
      </condition-set>
      <action directive=“Designated_addressBook_master” />
  </selection-rule>
  <selection-rule>
      <condition-set type=“and“>
        <condition name=“BusinessCriteria”
        value=“guaranteed volume − preferred
suppliers” />
      </condition-set>
      <action affinity=“Supplier_PREFERRED”
      directive=“RoundRobin” />
  </selection-rule>
  <selection-rule>
      <condition-set type=“and”>
        <condition name=“operation” value=“purchaseOrder” />
        <condition name=“Messagecontent”
        value=“Catagory=Electronics” />
      </condition-set>
      <action affinity=“BusinessCriteria_ElectronicsPurchasing”
        directive=“FixedOrder_Primary-then-Secondary” />
  </selection-rule>
  <BusinessCriteria name=“guaranteed volume − preferred suppliers”>
    <volume value=“1000” interval=“monthly” startdate=“11012002”
enddate=“05312003” />
  </BusinessCriteria>
  <BusinessCriteria name=“ElectronicsPurchasing”>
    <service name=“primeEcectronics” role=“PRIMARY” />
    <service name=“HQElectronics” role=“PRIMARY” />
    <service name=“Joe's” role=“SECONDARY” />
    <service name=“Peter's” role=“SECONDARY” />
    <service name=“Sam's” Role=“SECONDARY” />
  </BusinessCriteria>
<FixedOrder name=“Primary-then-Secondary”>
    <Service name=“*” role=“PRIMARY” />
    <Service name=“*” role“SECONDARY” />
  </FixedOrder>
  <FixedOrder name=“ControlMaster”>
    <service name=“first-in-command” />
    <service name=“second-in-command” />
    <service name=“third-in-command” />
    <service name=“fourth-in-command” />
  </FixedOrder>
</miscellaneous-section>
```

As the request is being processed herein, recovery system 28 will utilize a set of recovery rules in the service policy to address any errors or issues that arise. As described above, such errors could include, among other things, communication failures, security breaches, etc.

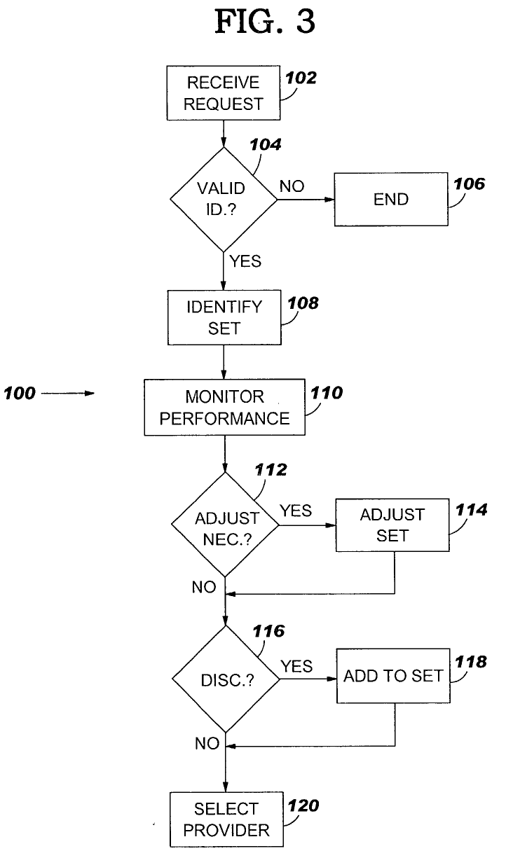

Referring now to FIG. 3 a method flow diagram 100 according to the present invention is shown. As depicted, a request is received in step 102. Upon receipt, it will be determined whether the identification of the sending user is valid based on a set of security rules in step 104. If the identification is not valid, the process is ended in step 106. If, however, the identification is valid, an initial set of service providers will be identified based on the request service and the set of mapping rules in the service policy in step 108. To provide dynamic variation of the set, the performances of the service providers will be monitored according to the set of monitoring rules in the service policy in step 110. It will then be determined whether any adjustments to the set are necessary based on the monitored performances in step 112. If adjustments are necessary, they will be made in step 114. Then, it will be determined whether any additional service providers from other grids have been discovered based on the set of discovery rules in the service policy in step 116. If other service providers have been discovered, they will be added to the set in step 118. In any event, one or more particular service providers will be selected from the set in step 120.

It is understood that under the present invention, the service policy is modular in that the rules therein are specified based on the type of grid being implemented. For example, a “service reference” type of grid may not need selection rules if it requires the query strings to be submitted with the service requests. It is further understood that the present invention can be realized in hardware, software, or a combination of hardware and software. Any kind of computer/server system(s)—or other apparatus adapted for carrying out the methods described herein—is suited. A typical combination of hardware and software could be a general purpose computer system with a computer program that, when loaded and executed, controls service system 10 such that it carries out the respective methods described herein. Alternatively, a specific use computer, containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

We claim:

1. A system for operating a grid of service providers based on a service policy, comprising:
a security system for validating an identity of a user transmitting a request based on the service policy, and for accessing a profile corresponding to the user;
a mapping system for identifying a set of the service providers in the grid capable of processing the request, wherein the set of service providers is identified based on the service policy, a user service level identified in the profile, and provider service levels corresponding to the service providers; and
a selection system for selecting a particular service provider from the set based on the service policy.

2. The system of claim 1, further comprising:
a discovery system for identifying additional service providers for the set from another grid based on a set of discovery rules in the service policy;
a registration system for the user and the service providers to register, wherein the user is assigned a user service level and the service providers are assigned provider service levels upon registration; and
a recovery system for addressing errors according to a set of recovery rules in the policy.

3. The system of claim 1, wherein the security system validates the identification based a set of security rules in the service policy.

4. The system of claim 1, wherein the mapping system identifies the set based on a set of mapping rules in the service policy, the user service level identified in the profile, and the provider service levels corresponding to the service providers.

5. The system of claim 1, wherein the selection system selects the particular service provider based on a set of selection rules in the service policy.

6. The system of claim 1, wherein the mapping system further monitors performances of the service providers, and revises the set based on the monitored performances.

7. The system of claim 6, wherein the performances are monitored with an event handler.

8. The system of claim 1, wherein the user service level and the provider service levels are based on a quality of service.

9. The system of claim 8, wherein the quality of service is based on factors that include availability and reliability.

10. A system for operating a grid of service providers based on a service policy, comprising:
a security system for validating an identity of a user transmitting a request based on a set of security rules in the service policy, and for accessing a profile corresponding to the user;
a mapping system for identifying a set of the service providers in the grid capable of processing the request, wherein the set of service providers is identified based on a set of mapping rules in the service policy, a user service level identified in the profile, and provider service levels corresponding to the service providers;
a discovery system for identifying additional service providers for the set from another grid based on a set of discovery rules in the service policy; and
a selection system for selecting a particular service provider from the set based on a set of selection rules in the service policy.

11. The system of claim 10, further comprising:
a registration system for the user and the service providers to register, wherein the user is assigned a user service level and the service providers are assigned provider service levels upon registration; and
a recovery system for addressing errors according to a set of recovery rules in the policy.

12. The system of claim 1, wherein the mapping system further monitors performances of the service providers, and revises the set based on the monitored performances.

13. The system of claim 12, wherein the performances are monitored with an event handler.

14. The system of claim 10, wherein the mapping system identifies the set by associating the user service level in the profile with the provider service levels according to the set of mapping rules.

15. The system of claim 10, wherein the user service level and the provider service levels are based on a quality of service, and wherein the quality of service is based on factors that include availability and reliability.

16. The system of claim 10, wherein the particular service provider is selected based on at least one of a business relationship factor and a user defined criterion.

17. A method for operating a grid of service providers based on a service policy, comprising:
receiving a request from a user, and validating an identity of the user based on a set of security rules in the service policy;
accessing a profile corresponding to the user;
identifying a set of the service providers in the grid capable of processing the request, wherein the set is identified based on a set of mapping rules in the service policy, a user service level identified in the profile, and provider service levels corresponding to the service providers; and
selecting a particular service provider from the set based on a set of selection rules in the service policy.

18. The method of claim 17, further comprising:
monitoring performances of the service providers with an event handler; and
revising the identified set based on the monitored performances.

19. The method of claim 17, further comprising discovering additional service providers for the set from another grid based on a set of discovery rules in the service policy.

20. The method of claim 17, further comprising:
providing a registration system for registering the user and the service providers; and
assigning a user service level to the user and provider service levels to the service providers upon registration.

21. The method of claim 17, further comprising providing a recovery system for addressing any errors according to a set of recovery rules in the policy.

22. The method of claim 17, wherein the identifying step comprises associating the user service level in the profile with the provider service levels, according to the set of mapping rules.

23. The method of claim 17, wherein the user service level and the provider service levels are based on a quality of service, and wherein the quality of service is based on factors that include availability and reliability.

24. The method of claim 17, wherein the selection step comprises selecting the particular service provider based on at least one of a business relationship factor and a user defined criterion.

25. A program product stored on a recordable medium for operating a grid of service providers based on a service policy, which when executed, comprises:
program code for validating an identity of a user transmitting a request based on a set of security rules in the service policy, and for accessing a profile corresponding to the user;
program code for identifying a set of the service providers in the grid capable of processing the request, wherein the set of service providers is identified based on a set of mapping rules in the service policy, a user service level identified in the profile, and provider service levels corresponding to the service providers; and
program code for selecting a particular service provider from the set based on a set of selection rules in the service policy.

26. The program product of claim 25, further comprising:
program code for discovering additional service providers for the set from another grid based on a set of discovery rules in the service policy;
program code for the user and the service providers to register, wherein the user is assigned a user service level and the service providers are assigned provider levels upon registration; and
program code for addressing errors according to a set of recovery rules in the policy.

27. The program product of claim 25, wherein the program code for identifying further monitors performances of the service providers and revises the set based on the monitored performances, and wherein the performances are monitored with an event handler.

28. The program product of claim 25, wherein the program code for identifying identifies the set by associating the user service level in the profile with the provider service levels, according to the set of mapping rules.

29. The program product of claim 25, wherein the user service level and the provider service levels are based on a quality of service, and wherein the quality of service is based on factors that include availability and reliability.

30. The program product of claim 25, wherein the particular service provider is selected based on at least one of a business relationship factor and a user defined criterion.
